(19) United States
(12) Patent Application Publication
(10) Pub. No.: US 2014/0146929 A1
(43) Pub. Date: May 29, 2014

(54) DEVICE FOR ELIMINATING LOCAL PERTURBATIONS FOR REFERENCE RECEIVER OF GNSS GROUND STATIONS

(71) Applicants: Franck Letestu, Bourg-de-peage (FR); Marc Revol, Upic (FR)

(72) Inventors: Franck Letestu, Bourg-de-peage (FR); Marc Revol, Upic (FR)

(73) Assignee: THALES, Neuilly-Sur-Seine (FR)

(21) Appl. No.: 13/996,484

(22) PCT Filed: Dec. 8, 2011
(86) PCT No.: PCT/EP11/72249

§ 371 Date: Jan. 24, 2014

(30) Foreign Application Priority Data
Dec. 23, 2010 (FR) 1005078

(51) Int. Cl. H04B 1/10

(52) U.S. Cl. CPC H04B 1/1081
USPC 375/349

(57) ABSTRACT

The present invention relates to a device for eliminating the perturbation signals received by a reference GNSS station.

The device has means for receiving a signal of interest that is transmitted via a satellite.

It likewise has means for receiving the perturbation signals, said means including means for receiving said perturbation signals that are isolated from the signal of interest.

It also has means for subtracting the perturbation signals from the signal of interest, said means including means for estimating the differential transfer function W between the reception channel for the signal of interest and the reception channel for the perturbation signals, so as to perform coherent subtraction of said signals.

The present invention relates to a device for eliminating the perturbing signals received on the antennas of the reference receivers for GNSS (Global Navigation Satellite System) ground stations. It applies more particularly in the case of ground infrastructures for system augmentations of SBAS (Satellite Based Augmentation Systems), GBAS (Ground Based Augmentation Systems), and LAAS (Local Area Augmentation System) type.

Reference GNSS stations, situated on the ground at positions that are known a priori, help to improve the positioning precision of navigation systems based on GNSS signals. Unfortunately, the measurements provided by these stations can be degraded for reasons linked to the local environment at the reference station. Notably, the reflections of the satellite signal from the structures situated in the local environment of the reception antenna can lead to multipaths. It may likewise contain electromagnetic interference sources, notably radiofrequency (RF) equipment situated in proximity to the station. The multipaths and the interference cause errors on the code and carrier phase measurements of the various GNSS satellite signals used.

The robustness of the reference stations toward multipaths and toward interference can be ensured by using a fixed reception antenna of FRPA (Fixed Radiated Pattern Antenna) type. These fixed antennas, whether antennas of “choke-ring” or helical type, are designed with the aim of using simple spatial filtering to make the difficult compromise between:
the detection and tracking of satellite signals from the lowest elevations, and;
the rejection of multipaths and interference, both predominantly situated at low elevations.

A major drawback of fixed antennas of FRPA type is not only that this compromise is very difficult to make at low elevation but also that such fixed antennas do not allow the receiver to be matched to the local environment of each station. The reason is that they have a fixed directivity pattern that is common to all stations, which involves weighty constraints on the specification of the installation sites. The use of fixed antennas lacks flexibility in the face of the variety of environments for the installation sites.

Studies are in progress to try to improve the robustness of FRPA antennas toward multipaths and toward interference by protecting them using mechanical protection structures called IMLP (Interference+Multipath Local Protection). These protections allow better control of reflections. However, such protections have the major drawback of being bulky, typically a diameter of from 5 to 10 meters and a height of from 2 to 3 meters, and of being expensive on account of the absorbent materials used.

The robustness of the reference stations toward multipaths and toward interference can likewise be ensured by virtue of frequency and temporal filtering processing operations that are performed at the receiver. Various filtering techniques are generally used depending on the nature of the perturbation. However, a major drawback of these techniques is that they are optimum only in a restricted field of assumptions relating to the nature of the perturbation. Since they are specialized, they require the implementation of as many dedicated algorithms, which are not without impact on the quality of the extracted measurements, notably on the stability of the phase biases and on the coherence between code phase and carrier phase. The multiplication of the algorithms also complicates the complexity of the validation of the performance of the reference station.

The adaptive spatial processing of an array antenna of CRPA (Controlled Radiation Pattern Antenna) type for forming a channel allows matching automatically and without a priori knowledge of the configuration of the installation sites. However, this type of processing has numerous drawbacks. Firstly, it involves the use of a complex array antenna and the implementation of the associated processing operations. Secondly, it results in receivers that are themselves also complex and especially sensitive to calibration impairments on the RF channels. Finally, this type of processing allows interference to be rejected but does not allow multipaths to be rejected.

The aim of the invention is notably to make GNSS reference stations robust both toward multipaths and toward interference linked to the installation sites of said stations, namely in a manner that is self-adaptive to the local environment of each site. To achieve this, it proposes forming coherent subtraction of the perturbing sources on the reception channel of the signal of interest, said sources including multipaths and interference. Reception channels subsequently called “reference perturbation channel” (VRP) are created, said VRPs allowing spatial isolation of multipaths and interference. To this end, the object of the invention is a device for eliminating the perturbation signals received by a reference GNSS station. The device has means for receiving a signal of interest that is transmitted by a satellite, said means including a main antenna with substantially omnidirectional radiation pattern. It likewise has means for receiving the perturbation signals, said means including a secondary antenna with a directional radiation pattern at low elevations and means for receiving said perturbation signals that are isolated from the signal of interest. It also has means for subtracting the perturbation signals from the signal of interest, said means including means for estimating the differential transfer function W between the reception channel for the signal of interest and the reception channel for the perturbation signals, so as to produce coherent subtraction of said signals.

By way of example, perturbation signals may include interference and indirect paths emanating from multiple reflections of the signal of interest.

Advantageously, the means for receiving the perturbation signals in isolation from the signal of interest may include means for maximizing the gain of the secondary antenna in the direction of the perturbation signals, and means for minimizing the gain of the secondary antenna in the direction of the signal of interest.

By way of example, the main antenna and the secondary antenna may be the antennas of one and the same LAAS station, the main antenna being able to be under closed loop control so as to track the signal of interest, the secondary antenna being able to be under open loop control from the main antenna, so as to orthogonalize the signal of interest and the perturbation signals.

By way of example, the differential transfer function W may be estimated by periodically calculating W=R⁻¹P, where R=E{Y(k)Y^{T}(k)} denotes the covariance matrix of the reception channel for the perturbation signals and P=E{X(k)Y^{T}(k)} denotes the intercorrelation vector between the two channels, X(k) and Y(k) denoting vectors associated with synchronized samples of the signal of interest and of the perturbation signals, respectively.

Advantageously, the subtraction may be performed on signals resulting from spectral despreading by correlation with the local code, following compensation for the difference W between said transfer functions by calculating Ŝ(k)=X(k)−W^{T}Y(k), where Ŝ(k) denotes an estimation of a sample of the signal of interest following compensation for the perturbations.

By way of example, the compensation for the difference W may he performed by means of an FIR filter arranged on the reception channel for the perturbations, the coefficients of the FIR filter being adjusted periodically.

Besides the simplicity of the coherent subtraction processing, a key advantage of the present invention is that it does not require a priori modeling of the nature of the perturbation sources and of the interfering signals. It is equally well suited to specular reflection as to diffuse reflection of multipaths, equally well suited to narrowband interference as to wideband interference, and equally well suited to continuous waves as to pulsed waves. The same processing applies equally to all types of perturbation and continues to be effective on any type of local environment of the reception stations: it does not require these environments to be checked a priori.

Other features and advantages of the invention will emerge from the description that follows with reference to the appended drawings, in which:

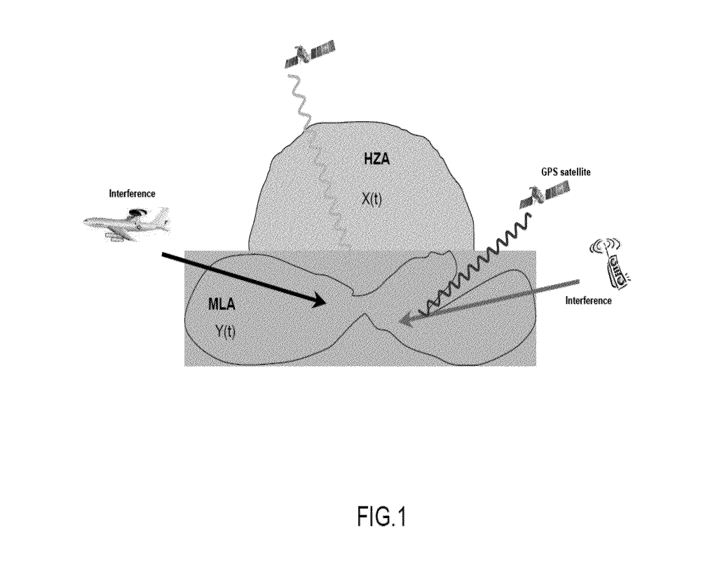

FIG. 1 uses a diagram to show an exemplary embodiment of an LAAS reference station according to the invention;

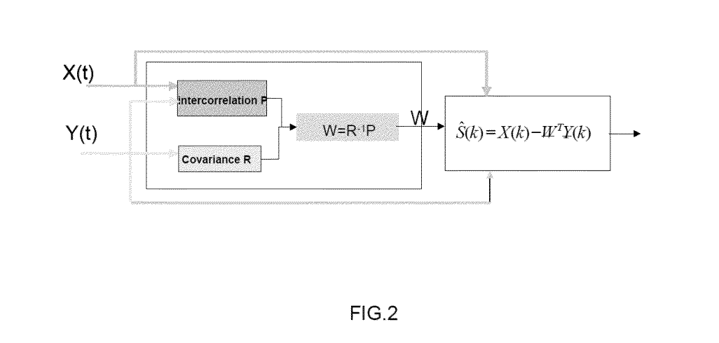

FIG. 2 uses a graph to show an example of combination of signals according to the invention;

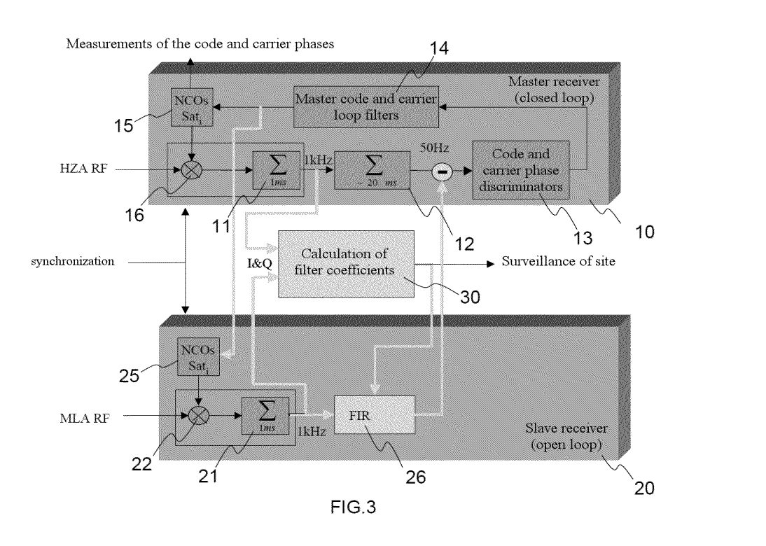

FIG. 3 uses a graph to show an exemplary embodiment of the invention applied to two equivalent tracking channels of the two receivers of an LAAS station.

In an elementary exemplary embodiment covering a majority of the configurations of installation sites of GNSS reference stations, a secondary antenna that is independent of the main reception antenna for the signals of interest transmitted by satellites can advantageously be used. The directivity of this secondary antenna can allow the reception of incident signals at low elevations, the low elevations forming the main sector of reception of multipaths and interference for ground transmitters, in a manner isolated from the signals of interest. Since the gain of this secondary antenna is greater on perturbation sources at low elevation than on signals of interest at high elevation that are situated outside this sector, a VRP provides an estimation of the perturbation signals that allows, with adaptive modeling of the transmission channels, coherent subtraction from the signal provided by the main antenna.

FIG. 1 uses a diagram to show an exemplary embodiment of the present invention in an LAAS reference station of IMLA (Integrated Multipath Limiting Antenna) type. This exemplary embodiment may have a main HZA (High Zenith Antenna) antenna for receiving signals of interest X(t) transmitted by a satellite at high elevations. This HZA antenna has a substantially omnidirectional radiation pattern as shown by FIG. 1. The present exemplary embodiment may likewise have a secondary MLA (Multipath Limiting Antenna) antenna for receiving perturbation signals Y(t) at low elevations, these perturbation signals Y(t) being able to be transmitted by airborne radars or mobile telephone networks, for example. This MLA antenna likewise has a directional radiation pattern. It should be noted that X(t) is perturbed by Y(t), that is to say that X(t) includes a perturbation component that the present invention proposes compensating for.

The spatial processing of the MLA antenna, notably the control of its radiation pattern, is optimized so as to continuously provide the best possible independence between a VRP formed by the MLA antenna and signals of interest X(t) emanating from a satellite. This is notably a matter of maximizing the gain of the MLA antenna in the direction of perturbation signals Y(t) and of minimizing the gain of the MLA antenna in the direction of signals X(t). The MLA antenna allows a plurality of VRPs to be formed, one VRP suited to each of the visible satellites. This makes it possible to provide, by means of orthogonalization, the best possible rejection between the satellite signals under consideration and all of the perturbation sources.

FIG. 2 uses a graph to show an example of combination according to the invention for the signals X(t) that are available on the main channel with the signals Y(t) that are available on the VRP. This involves performing coherent subtraction of the outputs of the two antennas, that is to say between the measurement channel of the main HZA antenna and the VRPs of the MLA antenna, without previously calibrating the processing channels that extend from the input port of each of the two antennas to the output of the signals for subtraction, these processing channels notably giving rise to a code and carrier phase bias. This can be accomplished by performing adaptive estimation of the differential transfer function W between the two processing channels. Thus, if X(k) and Y(k) denote the vectors associated with synchronized samples of the signal X(t) and the signal Y(t), respectively, then W can be calculated as follows:

W=R⁻¹P

where R=E{Y(k)Y^{T}(k)} denotes the covariance matrix of the VRP and P=E{X(k)Y^{T}(k)} denotes the intercorrelation matrix between the VRP and the main channel.

The subtraction is performed following compensation for the difference W between said transfer functions as follows:

\hat{S}(k)=X(k)−W^{T}Y(k)

where Ŝ(k) denotes an estimation of the sample of the signal of interest following compensation for the perturbations.

This compensation can be performed by means of transverse filtering applied to the VRP by virtue of an FIR (Finite Impulse Response) digital filter. This method makes it possible to observe the performance constraints imposed on reference stations in order to observe the phase of the satellite signals, notably by minimizing the variations in group delay (TPG) for the processing line.

Since the processing applies to the amplitude and to the phase of the received signals, it can be applied at reduced rate, which lessens the cost, following demodulation of the signals and spectral despreading by correlation with the local code, over the I&Q signals that are generally sampled at 50 Hz. The signals that are output from the demodulation of the local code are thus rid of the biases caused by multipaths and interference, prior to estimation of the group delay via the code discriminator and of the carrier phase delay by the phase discriminator.

In the LAAS station of the present exemplary embodiment, the main HZA antenna and the secondary MLA antenna have directivity patterns that are complementary in elevation for tracking satellite signals. This is the case with all LAAS stations. By coupling outputs, this allows homogeneous reception sensitivity to be provided for all elevations. However, this complementarity does not in any way contribute to improving robustness toward perturbations from the environment. The present invention advantageously proposes coupling the tracking processing operations of the two reception lines. Indeed, GNSS receivers conventionally implement tracking lines of code loop (DLL: Delay Lock Loop) and phase loop (PLL: Phase Lock Loop) type in a closed loop controlled by error differences. This thus supposes that the two processing lines receive the same satellites with sufficient sensitivity to ensure the continuity of each of the tracking operations.

The present invention now proposes using two antennas for the precise purpose of providing different elevation coverages in order to be able to assess perturbations without being hampered by the signal of interest: the present invention therefore compromises the simultaneous tracking of satellite signals on the two independent receivers, since one of the receivers does not have the signal of interest. However, owing to the augmentation of the contrast, the invention allows the tracking of satellites that are even situated in the elevated coverage area of the secondary antenna. This is not possible with conventional processing operations, which do not allow separation between a useful signal and a perturbation signal in this area.

The invention proposes subjugating the tracking processing of the receiver of the VRP to that of the receiver of the main channel. Thus, the receiver of the VRP works as an open loop. In the absence of a signal of interest on the VRP, the invention allows, following demodulation, collection of the signals that are characteristic of the single perturbations. The receiver of the main channel works in conventional fashion for its part, that is to say as a closed loop under the control of the reception phase of the signal of interest coming from the satellite. This signal, which is initially degraded by the local perturbations that are visible to the main antenna, is then cleared according to the invention by means of adaptive coherent subtraction of the perturbations estimated on the VRP.

FIG. 3 uses a graph to show an exemplary embodiment of the invention applied to two equivalent tracking channels of the two receivers 10 and 20 of the LAAS station tracking the same satellite. The two receivers 10 and 20 are partially synchronized. They are coupled by virtue of control of their respective NCOs 15 and 25 (Numerically Controlled Oscillator), in code and carrier phase. Only the master receiver 10 of the main antenna works as a closed loop. The slave receiver 20 of the secondary antenna works as an open loop, using the same servo-control as that of the main channel. It is thus ideally necessary to have as many coupled channels as visible satellites, The coherent subtraction between the two channels is effected following equalization of the differences that exist between the transfer functions of the two channels, that is to say the differences between the phase centers of the antennas, between the code and carrier phase biases of the RF analog channels. The equalization is performed in adaptive fashion and does not require prior calibration of the antennas and the RF lines. In practice, it is performed on the basis of the estimation of the intercorrelation matrix between the antenna channels. From the intercorrelation matrix, it is possible to estimate the differential transfer function of the two channels, which thus allows the running difference in the received perturbations to be compensated for. This compensation is effected by means of an FIR filter 26, the coefficients of which are calculated in real time by the module 30 in order to match the change in the transfer functions of the two reception lines, according to the direction of arrival of the satellites. The FIR filter is applied solely to the reference perturbation channel, so as not to perturb the measurements of the satellite signal that are performed on the main channel. The coefficients of the FIR filter are estimated in adaptive fashion by a module 30 from the I&Q signals taken following correlation by the local code, which preserves the phase information from the received signal and which allows a significant signal-to-noise ratio to be obtained. Since the errors caused by the perturbations progress slowly over time, essentially under the influence of the changes in the transfer functions of the antennas and the multipaths according to the direction of the satellites, it is possible to refresh the coefficients at a rate below 1 Hz, and to use demodulated signals in baseband and following spectral despreading by correlation with the local code. An FIR filter having fewer than 20 coefficients is sufficient to describe the differential transfer function precisely. However, the number of coefficients will be able to be proportioned on the basis of the performance that is aimed at.

In an improved embodiment, the VRPs can be matched to the configuration of installation sites of the reference stations, notably to the known sources of reflection of the signal and to the sources of interference,

It should be understood that the embodiment on the basis of two separate antennas that is described above is nonlimiting, other embodiments being envisageable, notably on the basis of a network antenna with beam agility. Indeed, the MLA antenna of an LAAS station CaO be made up of a set of antenna arrays with fixed apodization, that is to say a weighting coefficient per antenna in the network, this apodization making it possible to guarantee the desired pattern. The invention proposes making this apodization adaptive, so as to create a reception null in the direction of each of the GNSS satellites of interest, as shown by FIG. 1, which shows a null in the radiation pattern of the secondary antenna, this null being in the direction of a GPS satellite transmitting a signal of interest that is shown as a sine wave. To accomplish this, the invention proposes creating a “zero” for the directivity function of the secondary antenna in the direction of each of the satellites. This adaptive apodization can likewise be used to modify the pattern of the MLA antenna in order to take account of the specifics of the installation site of the reference GNSS station, so as to improve the performance of the system. Indeed, it is possible to increase the gain in the direction(s) of arrival of the interference, so as to better estimate the latter and hence to better cancel it by means of subtraction. This necessitates calculation of a set of coefficients for each of the tracked satellites, each set containing as many coefficients as there are antennas under consideration in the MLA network. Since the receiver of a reference GNSS station is fixed, this allows the coefficients to be refreshed slowly since the angular speed of movement of the satellites is likewise low.

One advantage of the present invention is that it directly allows interference to be detected and hence facilitates surveillance of the reference station site.

Another advantage of the present invention is that it can also allow optimization of the reception pattern of the secondary antenna so as to take account of the constraints specific to each installation site of the reference stations, such as the direction of multipaths and interference, with regard to the signals of interest.

Another advantage of the present invention is that the principles thereof can be extended to any device equipped with multiple VRP channels that are matched or otherwise to the configuration of each reference site for which the environment has been characterized in terms of directions of the sources of interference and/or of the sources of reflection of multipaths.

Another advantage of the present invention is that the VRP can be used to ensure independent surveillance of the installation sites, with a view to preventing the appearance of accidental or deliberate interference, or even of unforeseen reflection sources.

Another advantage of the present invention is that it can be implemented at low cost in an LAAS station, while preserving the existing architecture of the receivers therein.

1. A device for eliminating the disturbance signals received by a reference GNSS station, said device being characterized in that it has:
means for receiving a signal of interest that is transmitted by a satellite;
means for receiving the disturbance signals, said means including means for receiving said disturbance signals that are isolated from the signal of interest;
means for subtracting the disturbance signals from the signal of interest, said means including means for estimating the differential transfer function W between the reception channel for the signal of interest and the reception channel for the disturbance signals, so as to produce coherent subtraction of said signals,
said device being characterized in that:
said means for receiving a signal of interest transmitted by a satellite moreover include a main antenna having a substantially omnidirectional radiation pattern and
said means for receiving the disturbance signals moreover include a secondary antenna having a directional radiation pattern at low elevations.

2. The device as claimed in claim 1, characterized in that the means for receiving said disturbance signals in isolation from the signal of interest include:
means for maximizing the gain of the secondary antenna in the direction of the disturbance signals, and;
means for minimizing the gain of the secondary antenna in the direction of the signal of interest.

3. The device as claimed in claim 1, characterized in that the main antenna and the secondary antenna are the antennas of one and the same LAAS station, the main antenna being under closed loop control so as to track the signal of interest, the secondary antenna being under open loop control from the main antenna, so as to orthogonalize the signal of interest and the disturbance signals.

4. The device as claimed in claim 1, characterized in that the differential transfer function W is estimated by periodically calculating W=R⁻¹P, where R=E{Y(k)Y^{T}(k)} denotes the covariance matrix of the reception channel for the perturbation signals and P=E{X(k)Y^{T}(k)} denotes the intercorrelation vector between the two channels, X(k) and Y(k) denoting vectors associated with synchronized samples of the signal of interest and of the disturbance signals, respectively.

5. The device as claimed in Claim 1, characterized in that the subtraction is performed on signals resulting from spectral dispreading by correlation with the local code, following compensation for the difference W between said transfer functions by calculating Ŝ(k)=X(k)−W^{T}Y(k), where Ŝ(k) denotes an estimation of a sample of the signal of interest following compensation for the disturbances and X(k) and Y(k) denote vectors associated with synchronized samples of the signal of interest and the disturbance signals, respectively.

6. The device as claimed in claim 1, characterized in that the compensation for the difference W is performed by means of an FIR filter arranged on the reception channel for the disturbances, the coefficients of the FIR filter being adjusted periodically.

7. The device as claimed in claim 2, characterized in that the main antenna and the secondary antenna are the antennas of one and the same LAAS station, the main antenna being under closed loop control so as to track the signal of interest, the secondary antenna being under open loop control from the main antenna, so as to orthogonalize the signal of interest and the disturbance signals.

8. The device as claimed in claim 2, characterized in that the differential transfer function W is estimated by periodically calculating W=R⁻¹P, where R=E{Y(k)Y^{T}(k)} denotes the covariance matrix of the reception channel for the perturbation signals and P=E{X(k)Y^{T}(k)} denotes the intercorrelation vector between the two channels, X(k) and Y(k) denoting vectors associated with synchronized samples of the signal of interest and of the disturbance signals, respectively.

9. The device as claimed in claim 2, characterized in that the subtraction is performed on signals resulting from spectral dispreading by correlation with the local code, following compensation for the difference W between said transfer functions by calculating Ŝ(k)=X(k)−W^{T}Y(k), where Ŝ(k) denotes an estimation of a sample of the signal of interest following compensation for the disturbances and X(k) and Y(k) denote vectors associated with synchronized samples of the signal of interest and the disturbance signals, respectively.

10. The device as claimed in claim 2, characterized in that the compensation for the difference W is performed by means of an FIR filter arranged on the reception channel for the disturbances, the coefficients of the FIR filter being adjusted periodically.

11. The device as claimed in claim 3, characterized in that the differential transfer function W is estimated by periodically calculating W=R⁻¹P, where R=E{Y(k)Y^{T}(k)} denotes the covariance matrix of the reception channel for the perturbation signals and P=E{X(k)Y^{T}(k)} denotes the intercorrelation vector between the two channels, X(k) and Y(k) denoting vectors associated with synchronized samples of the signal of interest and of the disturbance signals, respectively.

12. The device as claimed in claim 3, characterized in that the subtraction is performed on signals resulting from spectral dispreading by correlation with the local code, following compensation for the difference W between said transfer functions by calculating Ŝ(k)=X(k)−W^{T}Y(k), where Ŝ(k) denotes an estimation of a sample of the signal of interest following compensation for the disturbances and X(k) and Y(k) denote vectors associated with synchronized samples of the signal of interest and the disturbance signals, respectively.

13. The device as claimed in claim 3, characterized in that the compensation for the difference W is performed by means of an FIR filter arranged on the reception channel for the disturbances, the coefficients of the FIR filter being adjusted periodically.

14. The device as claimed in claim 4, characterized in that the subtraction is performed on signals resulting from spectral dispreading by correlation with the local code, following compensation for the difference W between said transfer functions by calculating Ŝ(k)=X(k)−W^{T}Y(k), where Ŝ(k) denotes an estimation of a sample of the signal of interest following compensation for the disturbances and X(k) and Y(k) denote vectors associated with synchronized samples of the signal of interest and the disturbance signals, respectively.

15. The device as claimed in claim 4, characterized in that the compensation for the difference W is performed by means of an FIR filter arranged on the reception channel for the disturbances, the coefficients of the FIR filter being adjusted periodically.

16. The device as claimed in claim 5, characterized in that the compensation for the difference W is performed by means of an FIR filter arranged on the reception channel for the disturbances, the coefficients of the FIR filter being adjusted periodically.
